(19) United States
(12) Patent Application Publication
(10) Pub. No.: US 2025/0066097 A1
(43) Pub. Date: Feb. 27, 2025

(54) FIBER-BASED COMPOSITE MATERIAL FOR PADDING FOR MAILERS

(71) Applicant: Georgia-Pacific Corrugated LLC, Atlanta, GA (US)

(72) Inventors: Andrew Geoffrey Halcomb, Johns Creek, GA (US); Gary Norman Boettcher, Juliette, GA (US); Anand Viswanath, Marietta, GA (US); Marc Gerald Zanghi, Atlanta, GA (US)

(73) Assignee: Georgia-Pacific Corrugated LLC, Atlanta, GA (US)

(21) Appl. No.: 18/809,415

(22) Filed: Aug. 20, 2024

Related U.S. Application Data
(60) Provisional application No. 63/533,980, filed on Aug. 22, 2023.

(51) Int. Cl. B65D 81/03; B32B 3/26; B32B 29/00; B32B 29/08; B32B 37/24; B65B 55/00

(52) U.S. Cl. CPC B65D 81/03; B32B 3/266; B32B 29/002; B32B 29/08; B32B 37/24; B65B 55/00; B32B 2037/243; B32B 2255/12; B32B 2255/24; B32B 2255/28; B32B 2307/31; B32B 2553/02

(57) ABSTRACT

Fiber-based composite material for use in an automated packaging formation and padded mailers and corresponding systems and methods are provided herein. A fiber-based composite includes a fiber-based liner defining a liner width and a fiber-based padding defining a first surface and a second surface attached to the backing material to provide cushioning for items within a mailer. The fiber-based padding defines a padding width which is less than the liner width thereby defining a first liner overhang and a second liner overhang. A heat seal material is disposed on the first surface of the fiber-based padding, the first liner overhang and the second liner overhang to aid in heat seal formation between opposite surfaces when used to form a package. The heat seal material may, in some cases, includes an anti-stick additive.

### CROSS-REFERENCE TO RELATED APPLICATION(S)

This application claims priority to U.S. Provisional Application No. 63/533,980, entitled “Fiber-Based Composite Material for Padding for Mailers”, filed Aug. 22, 2023; the contents of which is incorporated by reference herein in its entirety.

### BACKGROUND OF THE INVENTION

There is an increased demand for delivery of items, such as directly to an end user's home or office. Further, the increased efficiency in the logistics of performing delivery has also driven up delivery capabilities. As such, there is an increased desire for the packaging to be environmentally friendly, while protecting the items within the delivered packaging.

Padded mailers are one such form of packaging option. Some examples of padded mailers include two panels that attach on at least three sides to create a pocket for holding an item (e.g., document, blister pack, batteries, retail product, etc.). Some padded mailers can be formed around the item for shipping and delivery, such as via automated padded mailer formation devices. Other example padded mailers are formed with an open pocket (such as by attaching three sides and leaving the fourth side open). Once such a padded mailer is formed, the item can be placed inside and the fourth side can be sealed-often by folding over a flap on one of the panels and sealing it to the other panel. Additional features, such as tear strips or pull-strip adhesive can be provided on the padded mailer for ease of packaging and/or opening. Some padded mailers form the paneling or other portions from plastic or other material that is non-recyclable.

Padded mailers, notably, also include padding, such as within internal pouches in one or more of the panels to provide cushioning and protection for the item inside the pocket. Unfortunately, many padded mailers are formed using plastic for the padding, such as via air cells or other technology. Such plastic, as noted above, however is typically non-recyclable. As such, there is a desire to form a more easily recyclable padded mailer.

### BRIEF SUMMARY OF THE INVENTION

Single face packaging material comprises padding material adhered to a liner web. To form a package from the single face package material, a scam or seal is formed by adhering opposing surfaces of the padding material. Applying a sealant material (e.g., adhesive) on the single face packaging material prior to formation of the package (but after formation of the single face packaging) may cause gaps in the seal due to the irregular, non-uniform shape of the padding material. In this regard, the gaps may decrease package integrity and ultimately may cause the package to open prior to reaching the consumer.

Some embodiments of the present invention form a recyclable padded material. In this regard, the padding may be formed utilizing a fiber-based material and attached to a liner web material. The fiber-based material may be adhered to the liner web with a recyclable adhesive. A recyclable heat seal material may be applied to the first surface of the fiber-based material and/or the liner material thereby aiding in the formation of padded mailers, and/or to form seals about a package formed in an automated packaging machine. The recyclable heat seal material may comprise a heat seal material and an anti-stick material to prevent the fiber-based padding from sticking to machinery prior to adherence to the fiber-based liner web. In some embodiments, the padding may be designed so as to not extend the full width of the liner so as to form overhangs that are free of padding. Such overhangs may include heat seal material and, thus, may effectively seal with each other when brought together (around the item) within an automated padded mailer formation device.

As noted above, the padding is easily recyclable, since the material uses recyclable papers, and, in some cases, a recyclable adhesive. As such, the corresponding padded mailer may, in some embodiments, be able to be introduced into the generally available curbside recycling stream.

As noted above, the composite material may work with automated machines that form the padded mailer around the item (e.g., as opposed to being hand-packed into a pouch). Alternatively, in some embodiments, the padded mailer could be pre-made (such as at a manufacturing facility) or could be formed at the customer site (e.g., where the article meant for mailing within the padded mailer is supplied).

In an example embodiment, a fiber based composite material for use in automated mailer packaging formation is provided. The fiber-based composite material comprises a fiber-based web defining a web width and a fiber-based padding defining a first surface and a second surface opposite the first surface. The second surface is adhered to the fiber-based web for providing cushioning. The fiber-based padding defines a fiber width which is less than the web width, thereby defining a first overhang extending between a first edge of the fiber-based padding and a first edge of the fiber-based web. The fiber-based composite material further defines a second overhang extending between a second edge of the fiber-based padding and a second edge of the fiber-based web. The fiber-based padding is formed of a plurality of tubular structures, each defining a longitudinal axis extending along the web width. The fiber-based composite material further comprises a heat seal coating disposed on the first surface of the fiber-based padding, the first overhang and the second overhang.

In some embodiments, the fiber-based web may define at least one score line. The score line may define a folding point along the fiber-based web. In some embodiments, the heat seal coating may comprise a mixture of a heat seal material and an anti-stick material. In some embodiments, the anti-stick material may be wax. In some embodiments, at least 3% of the heat seal coating comprises the anti-stick material. In some embodiments, less than 50% of the heat seal material comprises the anti-stick material.

In some embodiments, the heat seal coating may comprise at least one layer of heat seal material and a layer of an anti-stick material. In some embodiments, the anti-stick material may be wax. In some embodiments, the heat seal material may be applied to the first surface of the fiber-based padding and the anti-stick material may be applied over the heat seal material.

In some embodiments, the heat seal coating applied to the fiber-based padding may be a first heat seal material and the heat seal coating applied to the first overhang and the second overhang may be a second heat seal coating. In some embodiments, the first heat seal coating and the second heat seal coating may be different. In some embodiments, the fiber-based padding may be pre-crushed.

In another example embodiment, a method of forming a fiber-based composite material for use in automated packaging is provided. The method comprises applying a heat seal coating to a first surface of a fiber-based padding. The method further comprises adhering the fiber-based padding to a fiber-based web, wherein the fiber-based padding is fluted. the fiber-based web defines a web width and a web length. The fiber-based padding defines a padding width which is less than the web width, thereby defining a first overhang extending between a first edge of the fiber-based padding and a first edge of the fiber-based web and a second overhang extending between a second edge of the fiber-based padding and a second edge of the fiber-based web. The method further comprises applying a heat seal coating to the first overhang and the second overhang. The method further comprises adhering a second surface of the fiber-based padding to the fiber-based web.

In some embodiments, the method may further comprise mixing an anti-stick material into the heat seal coating. In some embodiments, between approximately 5% and 50% of the heat seal coating may comprise the anti-stick material. In some embodiments, the method may further comprise crushing the fiber-based padding. In some embodiments, the method may further comprise scoring a portion of the fiber-based liner.

In yet another example embodiment, a method of packaging an object is provided. The method comprises applying a heat seal coating to a first surface of a fiber-based padding. The method further comprises adhering the fiber-based padding to a fiber-based web, wherein the fiber-based padding is fluted. the fiber-based web defines a web width and a web length. The fiber-based padding defines a padding width which is less than the web width, thereby defining a first overhang extending between a first edge of the fiber-based padding and a first edge of the fiber-based web and a second overhang extending between a second edge of the fiber-based padding and a second edge of the fiber-based web. The method further comprises applying a heat seal coating to the first overhang and the second overhang. The method further comprises adhering a second surface of the fiber-based padding to the fiber-based web. The method further comprises positioning the object on the fiber-based padding and folding the fiber-based web over the object. The method further comprises applying heat to the fiber-based web thereby forming a heat seal about the object.

In some embodiments, the heat seal may be formed along the first overhang, the second overhang, and along a longitudinal axis of the fiber-based padding. In some embodiments, the heat seal coating may comprise an anti-stick material.

In yet another example embodiment, a fiber-based composite material for use in automated mailer packaging formation is provided. The fiber-based composite material comprises a fiber-based web defining a web width and a fiber-based padding defining a first surface and a second surface opposite the first surface. The second surface is adhered to the fiber-based web for providing cushioning. The fiber-based padding is formed of a plurality of tubular structures, each defining a longitudinal axis extending along the web width. The fiber-based composite material further comprises a heat seal coating. The heat seal coating comprises a heat seal material and an anti-stick material and is disposed on the first surface of the fiber-based padding.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A shows a top view of an example composite material with an example web liner and a fiber-based padding, in accordance with some embodiments discussed herein;

FIG. 1B shows a top view of another example composite material with an example web liner and a fiber-based padding, in accordance with some embodiments discussed herein;

FIG. 1C illustrates a cross-sectional view of the example composite material with an example web liner and fiber-based padding shown in FIG. 1A taken along line 1-1, in accordance with some embodiments discussed herein;

FIG. 2A illustrates a top perspective view of an example composite material with an example web liner and a fiber-based padding defining a first non-sinusoidal cross-sectional shape, in accordance with some embodiments discussed herein;

FIG. 2B illustrates a cross-sectional view of the example composite material with the example web liner and fiber-based padding shown in FIG. 2A taken along line 2-2, in accordance with some embodiments discussed herein;

FIG. 3 illustrates a schematic representation of an example system for forming a padded mailer from the composite material, in accordance with some embodiments discussed herein;

FIG. 4A illustrates a top view of the formation of an example padded mailer formed from the example automated padded mailer formation device shown in FIG. 3, in accordance with some embodiments discussed herein;

FIG. 4B illustrates a top view of the formation of an example padded mailer formed from the example automated padded mailer formation device shown in FIG. 3, in accordance with some embodiments discussed herein;

FIG. 4C shows an illustrative cross sectional view of the example package shown in FIG. 4B taken along line 3-3, in accordance with some embodiments discussed herein;

FIG. 5 illustrates a schematic representation of an example system for forming a padded mailer, in accordance with some embodiments discussed herein;

FIG. 6A illustrates a top view of an example padded mailer formed from the example padded mailer system shown in FIG. 5, in accordance with some embodiments discussed herein;

FIG. 6B shows an illustrative cross-sectional view of the example padded mailer shown in FIG. 6A, in accordance with some embodiments discussed herein;

FIG. 7 illustrates a flowchart of an example method for forming a padded mailer, in accordance with some embodiments discussed herein;

FIG. 8 illustrates a flowchart of an example method for forming a padded mailer, in accordance with some embodiments discussed herein; and

FIG. 9 shows a graph depicting heat seal strengths for differing compositions of heat seal coatings, in accordance with some embodiments discussed herein.

### DETAILED DESCRIPTION

Some example embodiments will now be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

The term “fiber-based” as used herein may refer to a material formed from fiber, such as from natural or synthetic sources. Such fiber may be a cellulose material known to chemists as a linear polysaccharide. Such fiber may, for example, come from wood, linens or fabric, plants, and/or wastepaper or other recycled paper products.

As noted herein, the composite material and/or the resulting structure, such as a padded mailer, is designed to be recyclable. The term “recyclable” as used herein may refer to a characteristic that enables something to be entered into recycling processes to be converted into new materials and/or objects. In some embodiments, the composite material and/or the resulting structure may be curbside recycled (e.g., it allows the composite material and/or the resulting structure to be introduced into the generally available curbside recycling stream).

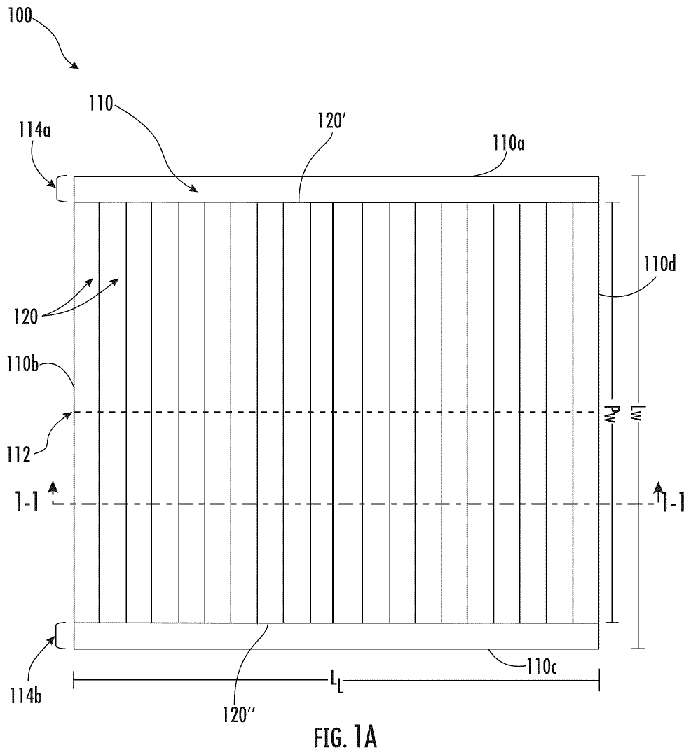

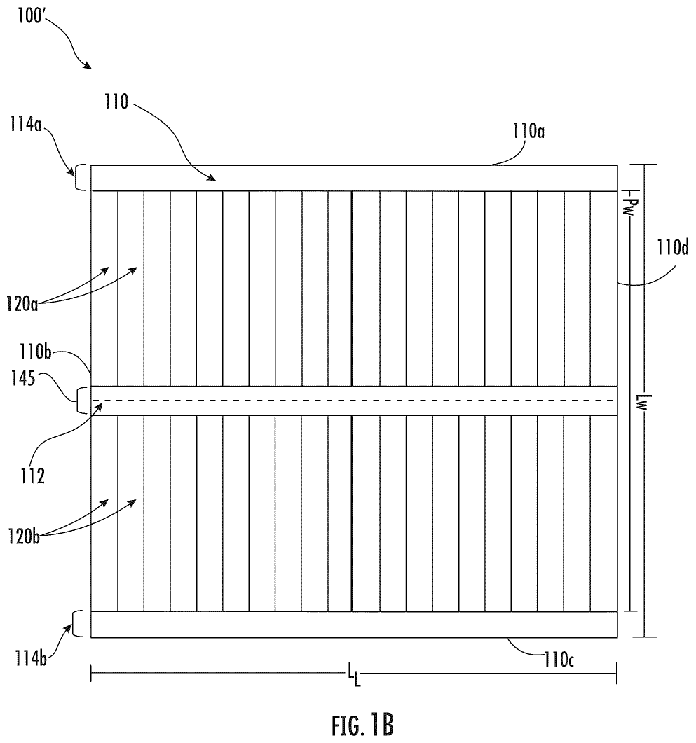

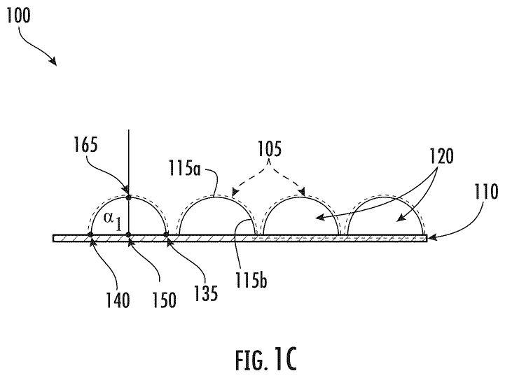

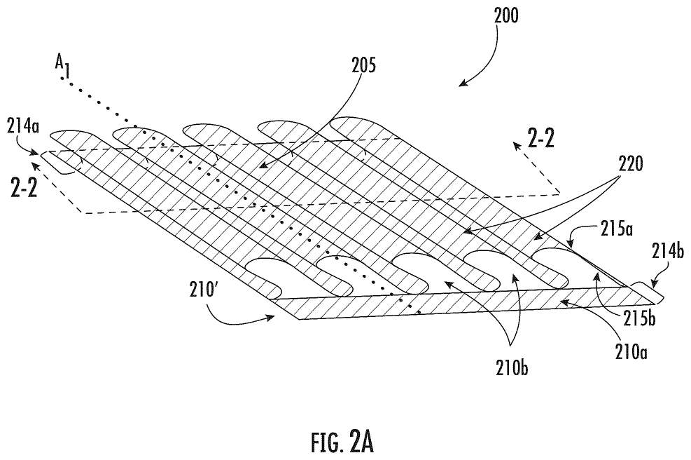

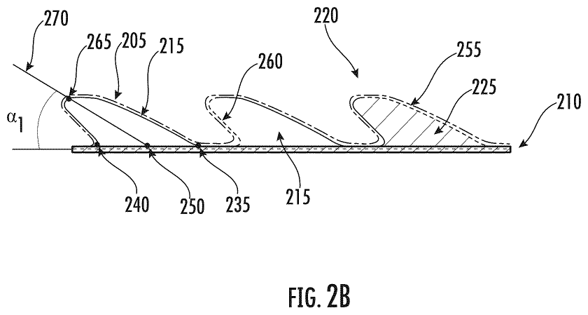

The term “sinusoidal” as used herein may refer to a smooth curve that has a shape corresponding to a sine curve (or a portion thereof). An example sinusoidal cross-sectional shape is shown in FIG. 1C. The term “non-sinusoidal” may refer to a curve or line that does not have a smooth curve with a shape corresponding to a sine curve. An example non-sinusoidal cross-sectional shapes are illustrated in FIGS. 2A-B.

The term “apex” as used herein may refer to a point that corresponds to a local maximum. For example, one or more points along a cross-section for a tubular structure that are furthest away vertically from a backing material may define apex points. Example apex points are illustrated and described with respect to FIG. 2B.

The term “uncrushed” as used herein may refer to a structure which has a sinusoidal cross-section. The term “crushed” as used herein may refer to a structure which has a non-sinusoidal cross-section.

The term “vertical” as used herein may refer to generally up and down (e.g., perpendicular) with respect to a plane corresponding to the composite material. To the extent a specific direction (e.g., up, down, side, etc.) is used, such terms are meant for explanatory purposes and are not designed to be limited to the specifically termed direction. In this regard, other directions are contemplated, such as based on different frames of reference.

FIG. 1A shows top view of an example fiber-based composite material 100 as contemplated by various embodiments of the present invention. The fiber-based composite material 100 includes a fiber-based web 110 and a fiber-based padding 115 (see e.g., FIG. 1C) attached to the web 110. The web 110 may be formed from a continuous web of fiber-based material.

The fiber-based padding 115 may comprise a first surface 115a (see e.g., FIG. 1C) and a second surface 115b opposite the first surface 115a. In some embodiments, the second surface 115b of the fiber-based padding 115 may be adhered to the web 110. The fiber-based padding 115 may, in some embodiments, be fluted prior to adhesion with the web 110. In some embodiments, the fiber-based padding 115 may be formed as a continuous web, while in other embodiments the fiber-based padding 115 may be formed in distinct pads or otherwise.

The fiber-based padding 115 may be formed of a plurality of tubular structures 120. In some embodiments, the fiber-based padding 115 may be attached to the web 110 via an adhesive, which may be recyclable. In some embodiments, the adhesive may comprise a starch additive. The plurality of tubular structures 120, in some embodiments, may be formed from attaching a continuous web of fiber-based material to the web 110 (e.g., at one or two attachment points). In some embodiments, the tubular structures 120 may be individually formed and attached to the web 110 (e.g., from distinct portions of fiber-based material).

In some embodiments, the plurality of tubular structures 120 may extend longitudinally on the web 110. To explain, the web 110 may define a first side 110a, a second side 110b, a third side 110c and a fourth side 110d. The first side 110a and the third side 110c may be parallel, similarly the second side 110b and the fourth side 110d may be parallel. In this regard, the first side 110a and the third side 110c may be perpendicular to the second side 110b and the fourth side 110d. In some embodiments, a length L_{L} of the web 110 may extend between the second side 110b and the fourth side 110d, and a width L_{W} may extend between the first side 110a and the third side 110c. Thus, each of the plurality of tubular structures 120 may extend between the first side 110a and the third side 110c and may be positioned adjacent to one another between the second side 110b and the fourth side 110d.

The tubular structures 120 may be parallel to each other and laterally spaced along the length L_{L} of the web 110. In some embodiments, the tubular structures 120 may be adjacent to one another along the length L_{L} of the web 110. In this regard, in some embodiments, there may be a space between each of the tubular structures 120 along the length L_{L} of the web 110, while in other embodiments, each of the tubular structures 120 may abut one another.

Each of the plurality of tubular structures 120 may define a padding width P_{W}. In some embodiments, the padding width P_{W} may extend partially along a width of the backing material L_{W}, thereby defining a first overhang 114a and a second overhang 114b. While in other embodiments, each of the plurality of tubular structures 120 may extend from the first side 110a to the third side 110c of the web 110.

As illustrated in FIG. 1A, the first overhang 114a may extend between the first side 110a of the web 110 and a first side 120′ of the plurality of tubular structures 120, and the second overhang 114b may extend between the third side 110c of the web 110 and a second side 120″ of the plurality of tubular structures 120. In some embodiments, the first overhang 114a and the second overhang 114b may be the same size. In this regard, the plurality of tubular structures 120 may be centered along the width L_{W} of the web 110. Further, the first overhang 114a and the second overhang 114b may define the difference in the width L_{W} of the web 110 and the padding width P_{W}.

In some embodiments, a score line 112 may be formed within the web 110. In some embodiments, the score line 112 may be a series of perforations, while in other embodiments the score line 112 may be a weakness formed in the web 110. In other embodiments, the score line 112 may be formed by a wheel configured to crush the plurality of tubular structures 120 The score line 112 may aid in package formation by providing a fold line within the web 110 to enable surrounding of an item to be packaged within the composite material 100, such as useful in conjunction with an automated padded mailer formation device.

In some embodiments, such as illustrated in FIG. 1B, each of the plurality of tubular structures 120 may comprise a first portion 120a and a second portion 120b separated by a fold region 145. The fold region 145 may be positioned such that each of the first portion 120a and the second portion 120b of the plurality of tubular structures 120 are evenly spaced along the width P_{W}. The fold region 145 may create a fold line for forming packaging out of the composite material 100′. As there are no tubular structures within the fold region 145 being crushed or manipulated to fold the composite material 100′ there along. In some embodiments, the fold region 145 may be formed in place of the score line 112, while in other embodiments the fold region 145 may be in addition to the score line 112.

In some embodiments, each of the plurality of tubular structures 120 may define a sinusoidal cross-sectional shape, such as illustrated in FIG. 1C (e.g., the cross-sectional shape of the fiber-based padding 115 may form a curve including the part attached to or running parallel with the web 110 that approximates a portion of a sinusoidal curve). In this regard, each of the plurality of tubular structures 120 may be formed from the fiber-based padding 115 extending between a first point of attachment 135 and a second point of attachment 140 with the web 110. In some embodiments, the fiber-based padding 115 may define a constant radius of curvature, while in other embodiments the fiber-based padding 115 may define a changing radius of curvature between the first point of attachment 135 and the second point of attachment 140. In some embodiments, the radius of curvature may be the greatest at the first point of attachment 135 and the second point of attachment 140, while in other embodiments the radius of curvature may be the smallest at the first point of attachment 135 and the second point of attachment 140.

The fiber-based padding 115 may define a center point 165, wherein the length of the fiber-based padding 115 is equal on either side. An angle α₁ may be formed between the center point 165 and the plane of the web 110. In some embodiments, the angle α₁ may be a right angle (e.g., 90°). In some embodiments, the center point 165 may be positioned at a local maximum on the fiber-based padding 115.

In order to facilitate package formation, such as via an automated padded mailer formation device, in some embodiments, a heat seal coating 105 may be applied onto the first surface 115a of the fiber-based padding 115 prior to application to the fiber based web 110. In some embodiments, the heat seal coating 105 may coat the entire first surface 115 of the fiber-based padding 115, while in other embodiments the heat seal coating 105 may be pattern applied to the first surface 115a of the fiber-based padding 115. The heat seal coating 105 may comprise a heat seal material and an anti-stick material. The heat seal coating may be applied via any application process, such as spraying, painting, roller application, including others and any combinations thereof.

The heat seal coating 105 may provide the desired heat seal strength while preventing sticking to the corrugator and/or other machinery in the process. To explain, in general corrugators and other machinery may heat up the medium prior to and/or during the corrugation process. Heat seal materials may become tacky and/or sticky when heated, as the heat seal is activated. Thus, a typical heat seal coating (e.g., without the anti-stick material) may cause the fiber-based padding to stick to the corrugator and/or transfer the heat seal coating from the fiber-based padding to the corrugator, each of which is undesirable. Thus, the addition of the anti-stick material adds anti-stick properties to the heat seal coating 105, thereby preventing sticking and/or transfer due to the heat seal material within the heat seal coating 105.

In some embodiments, the anti-stick material may prevent the fiber-based padding 115 coated with the heat seal material from sticking to the corrugator and/or other machinery. In this regard, the fiber-based padding 115 is able to avoid sticking when run on heated corrugating rolls, while the heat seal coating 105 provides an effectively high heat seal strength when heated and pressed against an opposing layer of the heat seal coating 105. Thus, the fiber-based padding 115, may be coated with the heat seal coating 105 prior to corrugation and application to the web 110.

In some embodiments, the heat seal material may be an ethylene vinyl acetate copolymer or terpolymer. The heat seal material may be water-based or solvent-based. In some embodiments, the anti-stick material may be a wax. In some embodiments, the anti-stick material may be a natural wax, for example, an animal-based wax (e.g., beeswax), a vegetable-based wax (e.g., carnauba wax), a carbon-based wax (e.g., montan wax) or an oil-based wax (e.g., paraffin wax), or combinations thereof. In other embodiments, the anti-stick material may be a semi-synthetic wax, for example amide wax, or modified montan wax. In other embodiments the anti-stick material may be a synthetic wax, for example a homopolymer-based wax (e.g., polyethylene, polypropylene, or Fischer-Tropsch), or a copolymer-based wax (e.g., ethylene vinyl acetate, or ethylene acrylic acid). In some embodiments, the anti-stick material may be an emulsified aqueous product.

In some embodiments, the heat seal coating 105 may be a mixture of the heat seal material and the anti-stick material, while in other embodiments, the anti-stick material may be layered onto the heat seal material (e.g., coated over) such that the heat seal material is sufficiently covered with the anti-stick material, thereby preventing sticking to the corrugator or other machinery. In some embodiments, each of the heat seal material and the anti-stick material may be aqueous, such that they are dispersible for overall formulation stability.

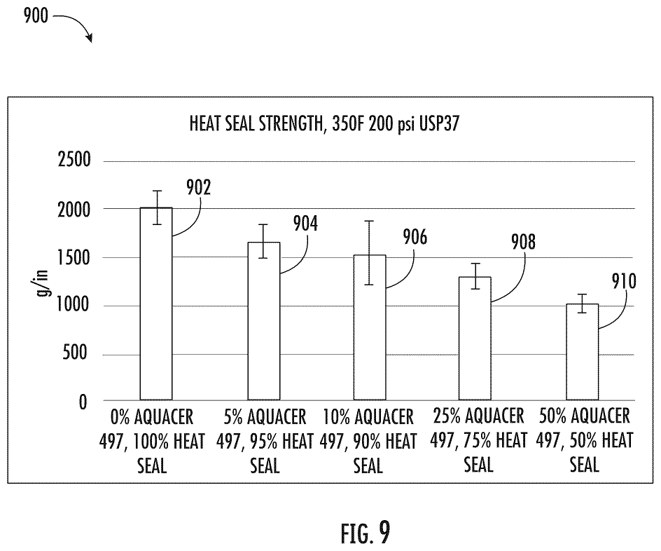

FIG. 9 illustrates a graph 900 of heat seal strengths measured at 350° F. and 200 PSI by various compositions of the heat seal material. In the test to determine the heat seal strengths, the heat seal coatings were coated on a 24.5 lbs/msf paper substrate with a #12 wire-wound Mayer rod, and cured at 100° C. for 3 minutes. The samples were conditioned at 95° F. and 30% relative humidity for 24 hours, followed by condition at 73° F. and 50% relative humidity for 24 hours. Heat seals were created by folding samples in half with heat seal sides facing each other, and sealing at 350° F. and 200 PSI, with a 0.5 second dwell time. The heat seal strength was measured at a 0.2 in/s peel rate. In the tests, the heat seal material used was an aqueous heat seal, and the anti-stick material used was Aquacer 497 from Byk.

In order to provide the desired package integrity the heat seal may require a heat seal strength of about 1,500 g/in, when heated and pressed against an opposing layer of the heat seal material. As illustrated in the graph 900, the relative greater amount of heat seal material present in the heat seal coating the higher the heat seal strength. As illustrated, a first composition 902 comprising 100% heat seal material provides a heat seal strength of about 2000 g/in. A second composition 904 comprising 95% heat seal material and 5% anti-stick material provides a heat seal strength of about 1,700 g/in. A third composition 906 comprising 90% heat seal material and 10% anti-stick material provides a heat seal strength of about 1,550 g/in. A fourth comprising 908 comprising 75% heat seal material and 25% anti-stick material provides a heat seal strength of about 1,300 g/in. A fifth composition 910 comprising 50% heat seal material and 50% anti-stick material provided a heat seal strength of about 1,050 g/in. Thus, compositions 1-3 provide the requisite heat seal strength for package integrity.

In addition to the heat seal strength, stickiness testing was performed on each sample. Each sample was positioned in a carver press where a section of the paper was in contact with steel platens at 900 lb force, at 300° F. for 30 seconds. The samples were removed from the platen to evaluate a visual assessment for the tendency of the coated paper to stick to the steel plate.

TABLE 1

| Reference | | Stickiness |
|---|---|---|
| number | Heat seal | Index |
| 902 | 0% Aquacer 497, 100% Heat Seal | — |
| 904 | 5% Aquacer 497, 95% heat seal | + |
| 906 | 10% Aquacer 497, 90% heat seal | ++ |
| 908 | 25% Aquacer 497, 75% heat seal | +++ |
| 910 | 50% Aquacer 497, 50% heat seal | +++ |

As illustrated in Table 1, the stickiness of the samples is rated from a “−−−” which indicates the stickiest heat seal, to a “+++” which indicates a slippery seal. The first composition 902, which provided the highest heat seal strength, also has a high degree of stick through the machinery. The second and third compositions 904, 906 which provide sufficient heat seal strength provide adequate slip to allow the coated padding material to proceed through fluting machinery and other machinery. The fourth composition 908 provides a lower heat seal strength and yields a slippery finish. Similarly, the fifth composition 910 provides an insufficient heat seal strength, but provides a slippery finish.

In this regard, it is desirable to achieve a balance between the heat seal strength and the stickiness of the heat seal coating, as the heat seal must be sufficiently strong to provide package integrity, while not sticking to the corrugator or other machinery prior to package formation.

In some embodiments, the heat seal coating 105 may be a mixture of the heat seal material and the anti-stick material. In some embodiments, the heat seal coating 105 may comprise between 50%-99% heat seal material by weight, preferably between 80%-99% heat seal material by weight, and more preferably between 90%-97% heat seal material by weight. The heat seal coating 105 may comprise between 1%-50% anti-stick material by weight, preferably, between 1%-20% anti-stick material by weight, and more preferably between 3%-10% anti-stick coating by weight.

Returning to FIG. 1C, in some embodiments, the heat seal coating 105, may comprise multiple layers of the heat seal material and the anti-stick material, provided the anti-stick coating is the topmost layer of the heat seal coating 105. In this regard, the heat seal coating 105 may comprise a layer of the heat seal material and a layer of the anti-stick material positioned on the heat seal material, wherein the heat seal material is positioned on the first surface 115a of the fiber-based padding, and the anti-stick material is positioned on the heat seal material opposite the first surface 115a of the fiber-based padding 115. In other embodiments, the heat seal material and the anti-stick coating may be combined prior to application onto the first surface 115a of the fiber-based padding 115.

Returning to FIGS. 1A-C, in some embodiments, the heat seal coating 105 may allow the composite material 100, 100′ to be processed through an automated packaging machine, such as an automated padded mailer formation device. In this regard, the heat seal coating 105 provides the surface for sealing on the corrugated surface, and the side seams, as the heat seal coating 105 is positioned on each of these surfaces.

In some embodiments, the heat seal coating 105 positioned on the fiber-based padding 115 may be different than the heat seal coating positioned on the first overhang 114a and the second overhang 114b. In this regard, since the first overhang 114a and the second overhang 114b are not exposed to the some elements of the corrugator, the anti-stick material may be unnecessary. However, in some embodiments the heat seal coating 105 applied to the first overhang 114a and the second overhang 114b may have the same composition as the heat seal coating 105 applied to the first surface 115a of the fiber-based padding 115.

In some embodiments, the fiber-based padding may be pre-crushed to improve the cushioning properties of the composite material, and to improve the flexibility of the fiber-based composite material. FIGS. 2A-B illustrate an example pre-crushed fiber-based composite material 200. The pre-crushed composite material 200 may define a fiber-based padding 215 comprising a first surface 215a and a second surface 215b. The second surface 215b of the fiber-based padding 215 may be attached to a fiber-based web 210. The fiber-based padding 215 may define a plurality of tubular structures 220 when positioned on and attached to the web 210. In some embodiments, the first surface 215a of the fiber-based padding 215 may comprise a heat seal coating 205. Similarly, a first overhang 214a and a second overhang 214b may be coated with the heat seal coating 205. In some embodiments, the heat seal coating 205 positioned on the first overhang 214a and the second overhang 214b may utilize the same formulation as the heat seal coating on the first surface of the fiber-based padding 215 (e.g., comprise the anti-stick material), while in other embodiments, the heat seal coating 205 on the first overhang 214a and the second overhang 214b may be different than the heat seal coating 205 on the first-surface 215a of the fiber-based padding 215.

In some embodiments, the fiber-based padding 215 may be formed in a non-sinusoidal cross-sectional shape. In this regard, in some embodiments, such a shape of the padding material may provide desirable protection (e.g., shock absorption, crush protection, etc.) of items during shipping and handling.

In some embodiments, such padded protection may be particularly beneficial for relatively lighter items, e.g., having a weight of 10 lbs. or less (e.g., 7 lbs. or less, 3 lbs. or less, etc.). Notably, it has been observed that a typical single-face fluted medium, which forms a sinusoidal cross-sectional shape (e.g., shown in FIGS. 1A-C), may not provide desirable protection (e.g., impact protection) for such lighter items. In this regard, one line of thinking is that the single-face fluted medium is too rigid for some such circumstances. A different non-sinusoidal cross-sectional shape (as detailed herein), however, has been observed to be an appropriate amount of rigidity that provides desirable protection (e.g., impact protection). Notably, the non-sinusoidal cross-sectional shape can also be adjusted or customized for the desired application, such as to specification requests by a customer (e.g., to protect a known item or set of known items). In this regard, the position of an apex point 265 of the perimeter and/or angle α₁ (such as described with respect to FIG. 2B) may be adjusted.

In some embodiments, the padding may be designed for use with items that may be smaller and designed to fit inside the pouch of some padded mailers (e.g., padded mailers with surface area of ˜5 sq. ft. or less, 4 sq. ft. or less, etc.). Notably, however, embodiments of the present invention are designed to work with any suitable size padded delivery or storage option and any suitable weight range of item stored therein. In some embodiments, the composite material may be provided in roll form and cut to a desired shape and/or size to provide customized padding solutions.

A fiber-based composite material with an example non-sinusoidal cross-sectional shape is illustrated in FIGS. 2A-B. FIG. 2A illustrates a top perspective view of a fiber-based composite material 200 including the web 210 and fiber-based padding 215 attached to the web 210. Notably, the fiber-based padding 215 forms a non-sinusoidal cross-sectional shape (e.g., a first example non-sinusoidal cross-sectional shape).

In this regard, FIG. 2B illustrates an example cross-sectional plane 225 of the composite material 200, where the cross-sectional plane 225 may extend perpendicular to the web 210 between a first point of attachment 235 and a second point of attachment 240 between the fiber-based padding 215 and the web 210. Each tubular structure 220 may include a center point 250 positioned along the web 210 in the center between the first point of attachment 235 and the second point of attachment 240 with respect to the web 210.

In some embodiments, the fiber-based padding 215 may form a non-sinusoidal cross-sectional shape that, for example, leans at an angle. To explain, in the illustrated embodiment, the fiber-based padding 215 includes a first portion 255, a second portion 260, and an apex point 265. The apex point 265 may be the point wherein the first portion 255 changes to the second portion 260 of the fiber-based padding 215. In some embodiments, the first portion 255 extends away from the web 210 from the first point of attachment 235 to the apex point 265, and the second portion 260 extends from the apex point 265 back towards the web 210 at the second point of attachment 240. In some embodiments, the first portion 255 of the fiber-based padding 215 extends in a first direction that is laterally towards a center point 250, and the second portion 255 of the fiber-based padding 215 extends away from the second point of attachment 240 in a second direction laterally away from the center point 250. In some embodiments, the apex point 265 may be laterally further away from the center point 250 than the second point of attachment 240. In some embodiments, the apex point 265 extends along the longitudinal axis A₁ of the tubular structure 220. In some embodiments, a line extending parallel to the longitudinal axis A₁ and including the apex point 265 may form a fold there along. In some embodiments, utilizing a cross-sectional shape such as described with respect to FIGS. 2A-B may be beneficial in allowing the material to readily bend in all directions for folding and forming of mailers, such as via automated packaging machine.

In some embodiments, a plane 270 may extend between the apex point 265 and the center point 250 and parallel to the longitudinal axis A₁. The plane 270 (when viewed in the cross-sectional plane 225) may define an angle α₁ with the web (which may correspond to its own plane—e.g., a web plane). In some embodiments, the angle α₁ may be within a range of 5° to 75° (although other ranges are contemplated, such as 5°-60°, 10°-60°, 15°-75°, 20°-45°, etc.). As shown in FIGS. 2A-2B, in some such embodiments, each of the tubular structures 220 may be oriented in the same direction (e.g., generally left in the view provided). In other embodiments, the tubular structures 220 may form different shapes (e.g., with different angles) and/or may be oriented differently from each other.

The fiber-based padding 215 may be formed into the non-sinusoidal cross-sectional shape in various ways. For example, in some embodiments, the fiber-based 215 may be formed into the shape by structuring the fiber-based material attaching to the backing material (e.g., around a correspondingly shaped removable structure) when forming the tubular structures. As another example, in some embodiments, the fiber-based padding 215 may be crushed (e.g., via application of one or more forces onto the fiber-based padding 215) to cause the fiber-based padding 215 to take on the non-sinusoidal cross-sectional shape (e.g., the fiber-based padding 215 shown in FIG. 2B may be in a “crushed state”). In some embodiments, the fiber-based padding 215 may enter the crushed state shown in FIG. 2B from an uncrushed state, such as may correspond to the sinusoidal cross-sectional shape shown in FIG. 1C. In some embodiments, an application of a crushing force applied in a direction not perpendicular to the web 210 may cause formation of a non-sinusoidal cross-sectional shape such as shown in FIG. 2B. In some embodiments, the direction of the crushing force may correlate to the angle α₁. In some embodiments, the fiber-based padding 215 may “bounce” back upwardly slightly after the crushing force is applied to form the non-sinusoidal cross-sectional shape.

Although the embodiment of the non-sinusoidal cross-section is shown such that the apex point 265 is shown extending beyond the second point of attachment 240, in some embodiments, the apex point may extend beyond the first point of attachment. Likewise, the apex point may not extend beyond either of the first point of attachment or the second point of attachment, but still be spaced laterally from the center point 250. Further, one of skill in the art would understand the first point of attachment, second point of attachment, and the first portion of the perimeter, and second portion of the perimeter are interchangeable. In some embodiments, there may be more than one apex point, such that a portion of the fiber-based padding 215 extends beyond each of the first point of attachment 235 and the second point of attachment 240.

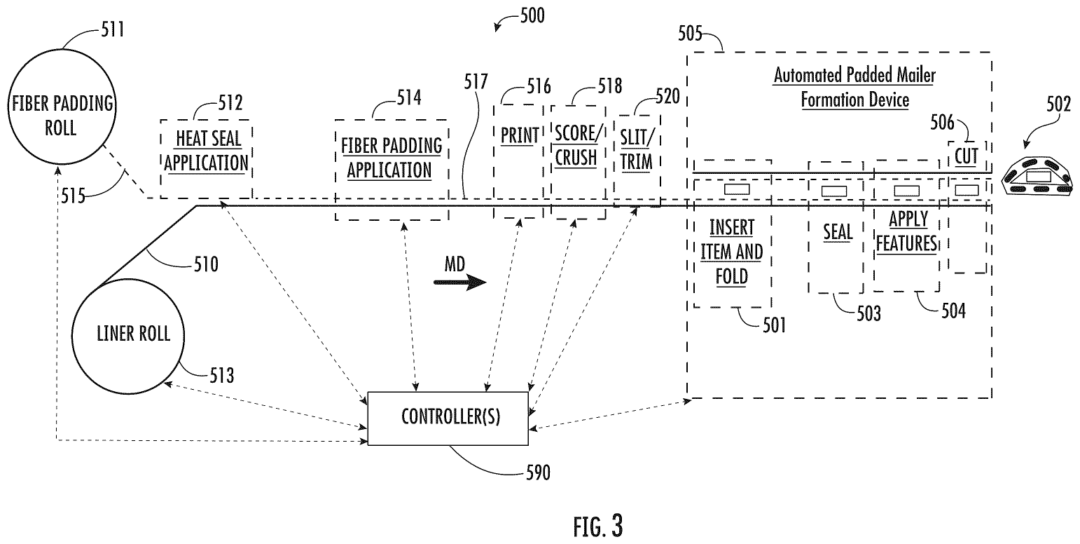

FIG. 3 illustrates a schematic representation of an example system 500 for forming a fiber-based package from the fiber-based composite material. The system 500, such as through controller 590, may cause conveyance of one or more paper-based webs, (i.e., a fiber-based web) such as along the machine direction (MD) arrow. The conveyor means (e.g., conveyor belt, one or more rollers etc.) and/or motors may be used to cause a roll 511 of a fiber-based padding 515 to pass through a heat seal application phase. At the heat seal application phase 512 the heat seal material (e.g., 105 FIG. 1C) may be applied to the first surface (e.g., 515a FIG. 1C) of the fiber-based padding 515. After that, the conveyor means may cause a first roll 513 of a fiber-based web 510 to be combined with the heat seal coated fiber-based padding at a fiber padding application phase 514. At the fiber padding application phase 514, the fiber-based padding may be attached (e.g., adhered) to the web material forming a padded fiber-based composite material web 517. In some embodiments, the fiber-based padding may be applied in an uncrushed state (e.g., in the sinusoidal shape shown in FIGS. 1A-C). Alternatively, the fiber-based padding may be applied into the desired non-sinusoidal shape, such as described herein.

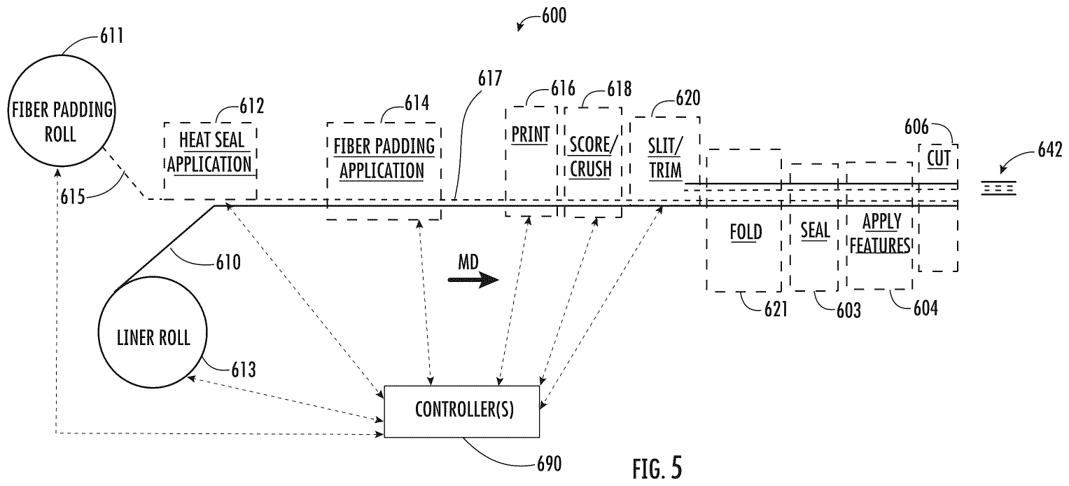

After formation of the composite material web 517, the conveyor means may cause the fiber-based composite material web 517 to pass through one or more of a print phase 516, a score/crush phase 518, and a slit/trim phase 520. In some embodiments, the fiber-based composite material web 517 may be rolled and shipped, such as to a packaging facility. In other embodiments, the composite material web 517 may be used in an automated padded mailer formation device 505 or formed into a padded mailer. FIG. 5 illustrates an additional example system 600 for forming a second padded mailer 642 as described herein.

Notably, in conjunction with various embodiments described herein, various phases can be combined, changed in the order of operation, separated, or otherwise changed. In such example embodiments, the corresponding phases may be adjusted accordingly.

The following provides further example description of the various features/components and/or phases corresponding to systems 500, 600. In this regard, depending on the type of tubular structure (e.g., sinusoidal or non-sinusoidal) different features/components may be employed.

The controller 590, 690 provides logic and control functionality used during operation of the system 500, 600. In some embodiments, the functionality of the controller 590, 690 may be distributed to several controllers that each provides more limited functionality to discrete portions of the operation of system 500, 600. The controller 590, 690 may comprise one or more suitable electronic device(s)/server(s) capable of executing described functionality via hardware and/or software control. In some embodiments, the controller 590, 690 may include one or more user interfaces (not shown), such as for displaying information and/or accepting instructions. The controller 590, 690 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The controller 590, 690 may include one or more processors coupled to a memory device. Controller 590, 690 may optionally be connected to one or more input/output (I/O) controllers or data interface devices (not shown). The memory may be any suitable form of memory such as an EPROM (Erasable Programmable Read Only Memory) chip, a flash memory chip, a disk drive, or the like. As such, the memory may store various data, protocols, instructions, computer program code, operational parameters, etc. In this regard, the controller 590, 690 may include operation control methods embodied in application code. These methods are embodied in computer instructions written to be executed by one or more processors, typically in the form of software. The software can be encoded in any suitable language, including, but not limited to, machine language, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any suitable combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the controller 590, 690 may be configured to execute computer program code instructions to perform aspects of various embodiments of the present invention described herein.

The controller 590,690 may be operably coupled with one or more components of the system 500, 600, including for example, the roll 513, 613 of line web 510, 610 (or corresponding web management device for controlling translation of the first web 510, 610 along the web path), the roll 511, 611 of the fiber-based padding 515, 615 (or corresponding web management device for controlling translation of the fiber-based padding 515, 615 along the web path), various components of the heat seal application phase 512, 612, various components of the fiber padding application phase 514, 614, various components of the printing phase 516, 616, various components of the score/crush phase 518, 618, various components of the slit and/or trim phase 520, 620, various components of the automated packaging phase 505 including various components of an insert and fold phase 501, various components of a seal phase 503, various components of an feature application phase 504 and/or various components of a cut phase 506, various components of the mailer formation including various components of a fold phase 621, various components of a seal phase 603, various components of an application of features phase 604 and/or various components of a cut phase 606, conveyance means of the system 500, 600, and other components (such as described herein). For example, depending on the components, the controller 590, 690 may be operably coupled such as through use of solid-core wiring, twisted pair wiring, coaxial cable, fiber optic cable, mechanical, electrical, wireless, radio, infrared, etc. In this regard, depending on the components, the operable coupling may be through one or more intermediate controllers or mechanical coupling, such as used for controlling some components (e.g., controlling operation and/or feeding of the roll 513, 613 of the first web 510, 610). In some embodiments, the controller 590, 690 may be configured to provide one or more operating signals to these components and to receive data from these components.

During the heat seal application phase 512, 612, the controller 590, 690 may be configured to cause application of the heat seal coating (e.g., 105) onto the first surface of the fiber-based padding 515, 615. The controller 590, 690 may apply the heat seal coating in layers including a layer of heat seal material coated with a layer of anti-stick material, or in other embodiments, the controller 590, 690 may be configured to mix an appropriate amount of the heat seal material and the anti-stick material into a heat seal coating and/or apply the heat seal coating to the first surface of the fiber-based padding 515, 615.

During the fiber padding application phase 514, 614, the controller 590, 690 may be configured to cause application of the fiber-based padding 515, 615 onto the first web 510, 610 (e.g., attachment of the fiber-based padding 515, 615 to the first web 510, 610). The controller 590, 690 may be further configured to apply an adhesive in a determined amount to the first web 510, 610 (e.g., at the first and second attachment points) and form fiber-based padding 515, 615 into a tubular structure with the appropriate cross-section, such as that seen in FIGS. 1A-2B. The fiber padding application phase 514, 614 may also involve cutting the fiber-based padding 515, 615 into individual pieces, which are each adhered to the continuous first web 614 of the web 510, 610. The fiber padding application phase 514, 614 may also involve cutting the fiber-based padding 515, 615 into two pieces, which are each adhered to the continuous first web 614 of the web 510, 610 forming a fold region therebetween.

During the printing phase 516, 616, the controller 590, 690 may direct a printer to print one or more images at specific locations on the first web 510, 610. Any suitable image (including words, markers, instructions, etc.) are contemplated by various embodiments of the present invention. For example, various labels corresponding to the padded mailer (and/or the composite material) may be printed onto the first web (such as the face of the first web that will face outside of the padded mailer). As another example, a barcode or other identifier may be printed to be used, such as during shipping and/or delivery.

During the score and/or crush phase 518, 618, the controller 590, 690 may be configured to score and/or crush the composite material 517, 617. Such scoring or crushing may be related to various features of the end product (e.g., crush a portion of the material corresponding to the edges or the strip adhesive, prepare the material for folding, etc.). Additionally or alternatively, in some embodiments, the crushing may be applied to the padding material such as to form the non-sinusoidal cross-sectional shapes (e.g., transition the padding material from an uncrushed state to a crushed stated). For example, the crushing may include application of a force to the padded composite material (e.g., perpendicular to or non-perpendicular to the backing material of the composite material). For example, the composite material may be passed under/through a roller or a plate and corresponding crushing may occur, such that the sinusoidal cross-sectional shape of the composite material is formed into a non-sinusoidal cross-sectional shape, yielding the desired shape of padded composite material.

Referring to FIG. 3, during the automated padded mailer formation device phase 505 the system causes conveyance of the padded composite material 517 in the automated padded mailer formation device 505. The automated padded mailer formation device 505 may perform various steps or phases with respect to the padded composite material 517 to produce a padded mailer with an item contained therein 502. For example, the automated padded mailer formation device 505 may, during an insert item and/or fold phase 501, cause the padded material 520 be folded around an item. In some cases, the fold may occur anywhere along the width of the padded material. In some cases, the fold may occur along a fold line, such as formed in some example padded material embodiments described herein. Then, during a seal phase 503, the device 505 may cause the two portions of the padded composite material 517 to be sealed together in the form of a padded mailer. In some embodiments, pressure and/or heat may be applied to one or more of the edges of the padded composite material 517 to cause the heat seal coating and/or other adhesive on the padded composite material 517 to adhere together to form the padded mailer. Thereafter, during an apply features phase 504, the device 505 may cause one or more features to be applied to the padded mailer, such as a tear-strip. Finally, the device 505, such as during a cut phase 506, may cause the padded mailer to be cut away from the remainder of the padded composite material 517—thereby forming the padded mailer with item inside 502.

Notably, in conjunction with various embodiments described herein, various of the phases can be combined, changed in order of operation, separated, or otherwise changed. In such example embodiments, the corresponding phases may be adjusted accordingly.

Some embodiments of the present invention contemplate other ways to create products, such as a padded mailer, from the padded composite material, as discussed with reference to FIG. 5. For example, a padded mailer with an opening for receiving an item may be formed. Such a padded mailer may then be “hand” packed with the item.

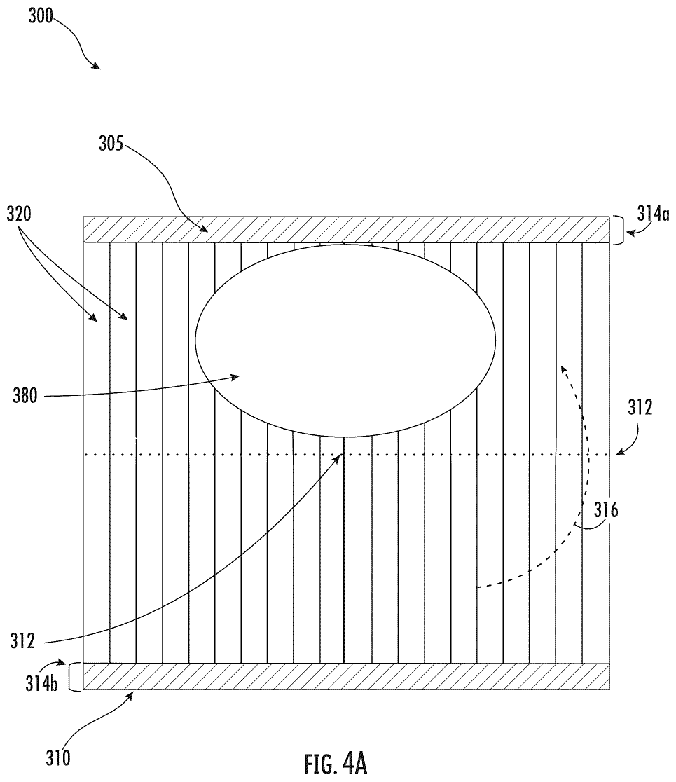

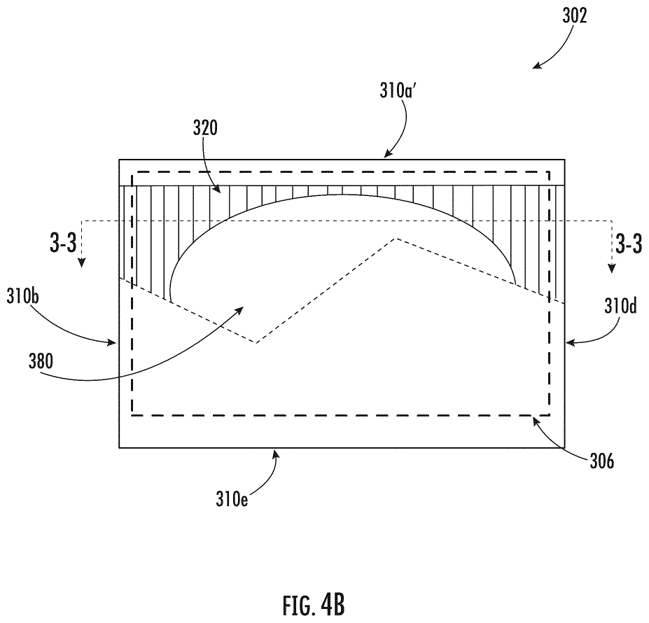

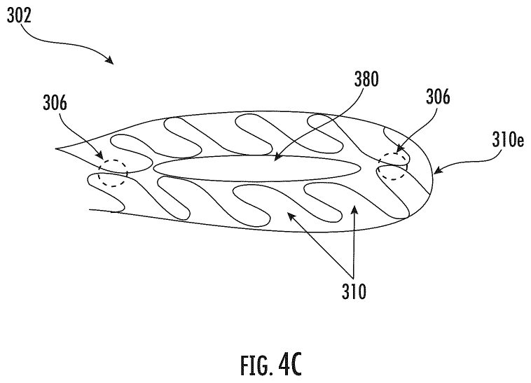

As detailed generally herein, the padded material may be used in automated packaging machines due to the configuration and position of the heat seal coating on the fiber-based padding. In this regard, the heat seal coating is configured to seal to the fiber-based padding, thereby retaining the fiber-based padding within the padded composite material regardless of where the padded composite material is cut and/or sealed. To explain, FIGS. 4A-4C illustrate steps in the process of forming a mailer with the automated packaging machine, such as discussed with reference to FIG. 3.

FIG. 4A illustrates a top view of the padded composite material 300 comprising a web 310 coated with a heat seal coating 305 on a first overhang 314a and a second overhang 314b with an object 380 positioned on top of the plurality of tubular structures 320 (notably, the heat seal coating is also applied to the plurality of tubular structures 320 as described herein). In the automated packaging machine, the padded composite material 300 may be folded over, indicated by arrow 316, the object 380 such as to bring the first overhang 314a into contact with the second overhang 314b. In some embodiments, the padded composite material 300 may be folded over a score line 312, while in other embodiments the padded composite material 300 may be folded over the fold region (e.g., 145 FIG. 1B).

FIG. 4B illustrates a top perspective view of the package 302 after formation in the automated packaging machine. Upon folding of the composite padded material 300 the package 302 comprises a first edge 310a′ (which include the first overhang 314a and the second overhang 314b), a second edge 310b, a folded edge 310e (e.g., formed at the score line 312) and a fourth edge 310d. The padded composite material 300 is subjected to heat and pressure to form a heat seal 306 about the object 380. The heat seal 306 may be located inward from each of the edges 310a′, 310b, 310e, and 310d.

FIG. 4C illustrates a cross-sectional view of the package 302 taken along line 3-3. In some embodiments, the heat seal 306 may be formed between two or more of the plurality of tubular structures 320. In this regard, since each of the outer surfaces (e.g., first surfaces) of the fiber-based padding is coated with the heat seal coating, the heat seal 306 may form at any and all contact points between the tubular structures 320 which are subjected to the heat and/or pressure to form the heat seal 306. In some embodiments, the heat seal 306 may be formed about the entirety of the object 380, however, in some embodiments, the new third edge 310e, or the folded edge, may not be subjected to the heat and/or pressure to form the heat seal 306 as the edge is sealed via the fold in the padded composite material 300.

In some embodiments, a package may be formed as a padded mailer to be filled and sealed by a consumer. FIG. 5 illustrates a system 600, for forming a padded mailer package 642. As discussed, the system 600 may, such as through controller 690, may cause conveyance of one or more paper-based webs (e.g., a fiber-based web), such as along the machine direction (MD) arrow. The conveyor means (e.g., conveyor belt, one or more rollers etc.) and/or motors may be used to cause a roll 611 of a fiber-based padding 615 to pass through a heat seal application phase. At the heat seal application phase 612 the heat seal material (e.g., 105 in FIG. 1C) may be applied to the first surface (e.g., 115a in FIG. 1C) of the fiber-based padding 615. After that, the conveyor means may cause a first roll 613 of a fiber-based web 610 to be combined with the heat seal coated fiber-based padding at a fiber padding application phase 614. At the fiber padding application phase 614, the fiber-based padding may be attached (e.g., adhered) to the web material forming a padded fiber-based composite material web 617. In some embodiments, the fiber-based padding may be applied in an uncrushed state (e.g., in the sinusoidal shape shown in FIGS. 1A-C). Alternatively, the fiber-based padding may be applied into the desired non-sinusoidal shape, such as described herein.

After formation of the composite material web 617, the conveyor means may cause the fiber-based composite material web 617 to pass through one or more of a print phase 616, a score/crush phase 618, and a slit/trim phase 620. In some embodiments, the fiber-based composite material web 617 may be formed into a padded mailer 642. Thus, the padded composite material web 617 may pass through a fold phase 621, a seal phase 603, a feature application phase 604, and a cut phase 606.

During the folding phase 621, one or more folds may be applied to the web of padded mailer. This may help form various features, such as the top flap. In some embodiments, the folding phase 621 may be utilized to fold over the composite material so as to form both panels (such as described above).

During the seal phase 603, the controller 690 may be configured to apply heat and/or pressure to the folded padded composite material to thereby form the padded mailer structure. In some embodiments, the seal phase 603 may utilize a heat seal applied about the edges of the padded mailer 642.

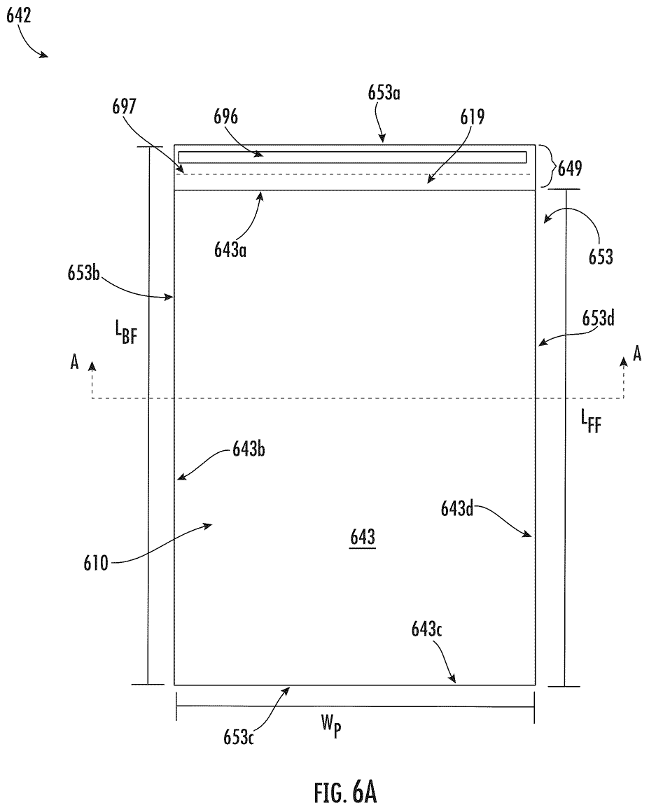

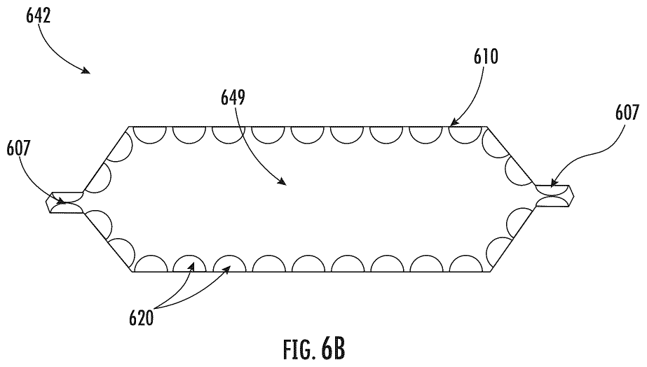

In some embodiments, a portion of at least one edge of each of the padded composite material may not be sealed so as to form an opening of the padded mailer. Thereafter, during an apply feature phase 604, the controller 690 may be configured to cause application of one or more features to the padded mailer, such as may be used for packaging and/or opening of the padded mailer. For example, with reference to FIG. 6A, a strip of adhesive and a corresponding pull-strip for revealing the strip of adhesive can be applied. As another example, a tear strip can be applied. Other features or additions to the padded mailer are also contemplated.

During the cut phase 641, the controller 690 may be configured to cut out the padded mailers (which may still be connected along their lengths since they may be folded as a web form). In this regard, the controller 690 may be operably coupled to the various knives to control operation during the cutting phase 606. After the padded mailer is cut additional processing and logistics corresponding with the manufacturing process may thereafter take place.

FIGS. 6A-6B illustrate views of the padded mailer 642 formed by the system 600 as contemplated by various embodiments. The illustrated padded mailer 642, which is shown in the open, ready for packaging configuration, includes a front panel 643 and a back panel 653. In some embodiments, the front panel 643 and the back panel 653 are formed from the same padded composite material, while in other embodiments the front panel 643 and the back panel 653 may be formed from distinct padded composite materials. The front panel 643 defines a width W_{P} and a length L_{FF} and includes four edges 643a, 643b, 643c, and 643d. The back panel 453 defines a width W_{P} and a length L_{BP} and includes four edges 653a, 653b, 653c, and 653d. In the open, ready for packaging configuration, the front panel 643 and the back panel 653 are attached along three edges (643b/653b, 643c/643c, and 643d/653d), such as via seam adhesive, or heat seal coating being positioned proximate the edges. Notably, in the illustrated embodiment, the first edge 643a of the front panel 643 is not attached to the back panel 653 (or only attached near the corners) and, instead, an opening 619 to a pocket 649 (shown in FIG. 6B) is formed—allowing insertion of the item(s) for shipping and delivery.

The dimensions of the padded mailer may vary depending on the desired application. An example padded mailer includes a back panel length L_{BP} of ˜20.125 in. and a back panel width W_{P} of ˜14 in.

Notably, the length L_{BP} of the back panel 653 is greater than the length L_{FF} of the front panel 643 such that a portion 649 of the back panel 653 extends above the fourth edge 653d of the front panel 653. The portion 649 of the back panel 653 can, thus, be used in sealing the padded mailer 642, such as to seal an item to be shipped and delivered inside. In this regard, various features for aiding in packaging and opening of the padded mailer can be positioned within the portion 649. For example, FIG. 6A illustrates an example pull-strip 696 for revealing a strip of adhesive that can be used to attach the portion 649 to the front panel 643 once the portion 649 has been folded over to cover the opening 619—thereby transitioning the padded mailer into the sealed configuration. Once the sealed padded mailer has been delivered to its end destination, a tear strip 697 can be pulled to enable access to the internal pocket 649 and, thus, the item stored therein.

Notably, embodiments of the present invention contemplate various features and configurations of a padded mailer that can be utilized. Thus, the illustrated example is not meant to be limiting. For example, in some embodiments, the front panel and the back panel may have similar lengths, the front panel and the back panel may be attached around an item, and/or other configurations are contemplated. In this regard, as described herein, the padded material can be used in conjunction with a padded mailer formation machine to enclose and form around an item. One or more of the above noted features (e.g., pull-strip 697) may be utilized for such a padded mailer that is formed.

With reference to FIG. 6B (which illustrates a cross-sectional view of the padded mailer 642 taken along line A-A in FIG. 6A), in the illustrated embodiment, the panels 643, 653 connect along the edges 607 to form the pocket 649 for receiving the item (e.g., 380 FIG. 3) to be shipped and delivered therein. In some embodiments the heat seal coating present on the plurality of tubular structures 620 may be pressure sealed together (e.g., with heat, for example) along the edges 607 to form the pocket 649 for receiving the item. Additionally or alternatively, in some embodiments, the two side edges 607 may be adhered together along the length dimension using a recyclable adhesive and no heat seal coating may be applied.

### Example Flowchart(s)

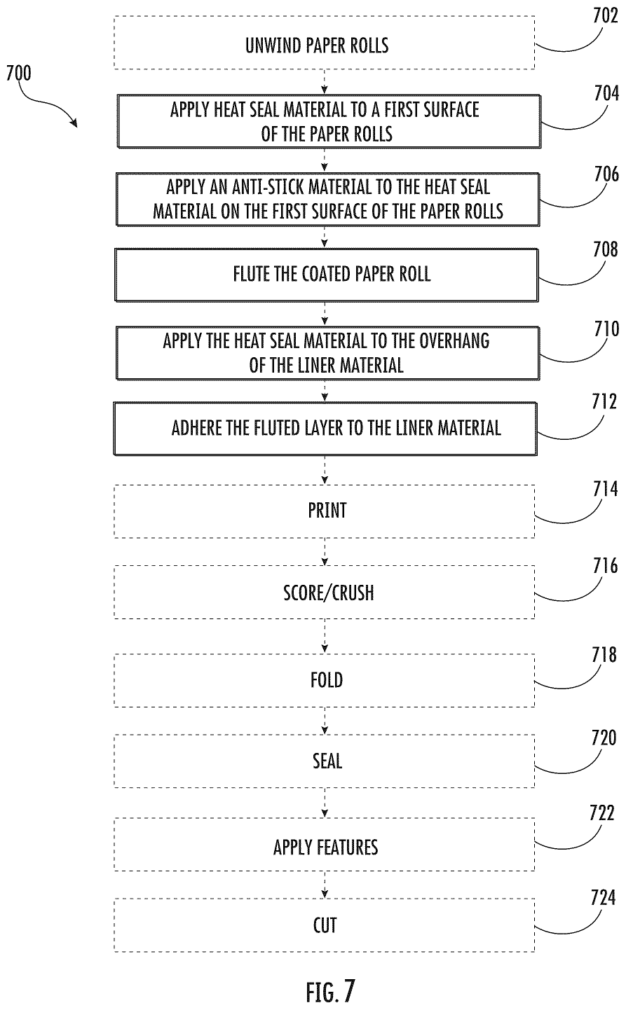

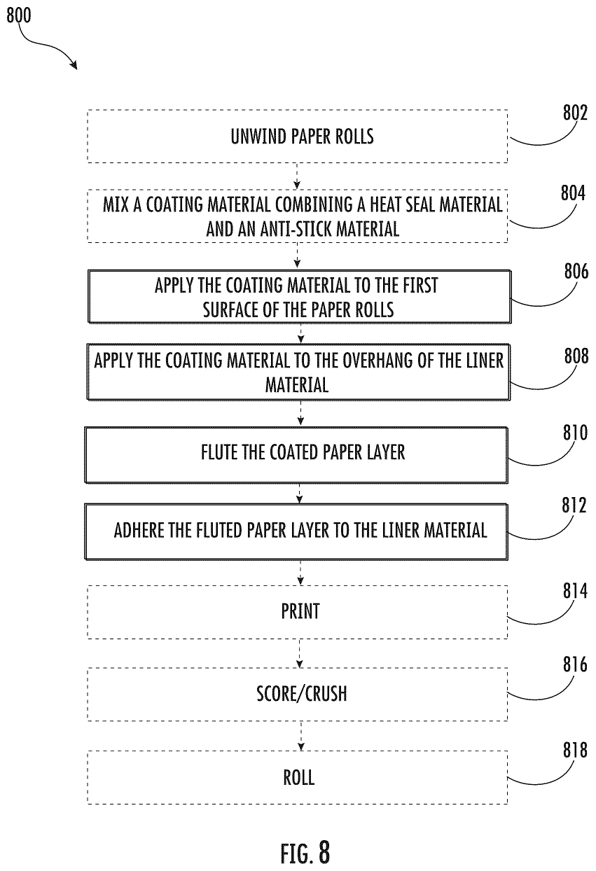

Embodiments of the present invention provide methods, apparatuses and computer program products for controlling the various components/features according to various systems described herein. Various examples of the operations performed in accordance with embodiment of the present invention will now be provided with reference to FIGS. 7-8.

FIG. 7 illustrates a flowchart according to an example method for forming a package from a padded fiber-based composite material according to an embodiment. The operations illustrated in and described with respect to FIG. 7 may, for example, be performed by, with the assistance of, and/or under the control of one or more controller 590, 690 and other components/features described herein, such as in the system 500, 600.

The method 700 may include unwinding one or more rolls at operation 702 (e.g., the fiber padding roll 511 and/or the liner web 513). At operation 704, the method may comprise applying heat seal material to a first surface of the fiber-based padding. At operation 706, the method may comprise applying an anti-stick material to the heat seal material on the first surface of the fiber-based padding. At operation 708, the method may comprise fluting the coated fiber-based padding. At operation 710, the method may comprise applying the heat seal material to the overhang of the liner web. At operation 712, the method may comprise adhering the fluted fiber-based padding to the liner web.

Optionally, at operation 714, the method may comprise printing on the liner web. At operation 716, the method may comprise scoring and/or crushing the fiber-based padding. At operation 718, the method may comprise folding the composite padding material. At operation 720, the method may comprise sealing, for example with heat and/or pressure, the composite padding material. At operation 722, various features may be applied to the composite package. At operation 724, the method may comprise cutting the padded composite package.

FIG. 8 illustrates a flowchart according to an example method for forming a padded composite material according to an example embodiment. The operations illustrated in and described with respect to FIG. 8 may, for example, be performed by, with the assistance of, and/or under the control of one or more controller 590, 690 and other components/features described herein, such as in the system 500, 600.

The method 800 may include unwinding one or more rolls at operation 802 (e.g., the fiber padding roll 511 and/or the liner web 513). At operation 804, the method may comprise mixing a coating material by combining a heat seal material and an anti-stick material (although in some embodiments the heat seal material and the anti-stick material may be applied separately, such as in layers). At operation 806, the method may comprise applying coating material to a first surface of the fiber-based padding. At operation 808, the method may comprise applying the coating material to the overhang of the liner web. At operation 810, the method may comprise fluting the coated fiber-based padding. At operation 812, the method may comprise adhering the fluted fiber-based padding to the liner web.

Optionally, at operation 814, the method may comprise printing on the liner web. At operation 816, the method may comprise scoring and/or crushing the fiber-based padding. At operation 818, the method may comprise rolling the fiber-based composite material into a roll for later use. For example to be shipped and/or used with an automated packaging machine.

FIGS. 7-8 illustrate flowcharts of various systems, methods, and computer program product according to various example embodiments described herein. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the controller 590, 690. As will be appreciated, any suitable such computer program product may be loaded onto a computer or other programmable apparatus, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A fiber-based composite material for use in automated mailer packaging formation, the fiber-based composite material comprising:
a fiber-based web defining a web width;
a fiber-based padding defining a first surface and a second surface opposite the first surface, wherein the second surface is adhered to the fiber-based web for providing cushioning,
wherein the fiber-based padding defines a padding width, wherein the padding width is less than the web width, thereby defining a first overhang extending between a first edge of the fiber-based padding and a first edge of the fiber-based web, and a second overhang extending between a second edge the fiber-based padding and a second edge of the fiber-based web,
wherein the fiber-based padding is formed of a plurality of tubular structures, wherein each of the plurality of tubular structures defines a longitudinal axis extending along the web width; and
a heat seal coating disposed on the first surface of the fiber-based padding, the first overhang, and the second overhang.

2. The fiber-based composite material of claim 1, wherein the fiber-based web defines at least one score line, wherein the at least one score line defines a folding point along the fiber-based web.

3. The fiber-based composite material of claim 1, wherein the heat seal coating comprises a mixture of a heat seal material and an anti-stick material.

4. The fiber-based composite material of claim 3, wherein the anti-stick material is wax.

5. The fiber-based composite material of claim 3, wherein at least 3% of the heat seal coating comprises the anti-stick material.

6. The fiber-based composite material of claim 3, wherein less than 50% of the heat seal material comprises the anti-stick material.

7. The fiber-based composite material of claim 1, wherein the heat seal coating comprises at least one layer of a heat seal material and a layer of an anti-stick material.

8. The fiber-based material of claim 7, wherein the anti-stick material is wax.

9. The fiber-based material of claim 7, wherein the heat seal material is applied to the first surface of the fiber-based padding and the anti-stick material is applied over the heat seal material.

10. The fiber-based material of claim 1, wherein the heat seal coating applied to the fiber-based padding is a first heat seal coating, and the heat seal coating applied to the first overhang and the second overhang is a second heat seal coating, wherein the first heat seal coating and the second heat seal coating are different.

11. The fiber-based material of claim 1, wherein the fiber-based padding is pre-crushed.

12. A method of forming a fiber-based composite material for use in automated packaging, the method comprising:
applying a heat seal coating to a first surface of a fiber-based padding;
adhering the fiber-based padding to a fiber-based web, wherein the fiber-based padding is fluted, wherein the fiber-based web defines a web width and a web length, and wherein the fiber-based padding defines a padding width, wherein the padding width is less than the web width, thereby defining a first overhang extending between a first edge of the fiber-based padding and a first edge of the fiber-based web, and a second overhang extending between a second edge the fiber-based padding and a second edge of the fiber-based web;
applying the heat seal coating to the first overhang and the second overhang; and
adhering a second surface of the fiber-based padding to the fiber-based web.

13. The method of claim 12 further comprising:
applying an anti-stick material over at least a portion of the heat seal coating.

14. The method of claim 12, further comprising:
mixing an anti-stick material into the heat seal coating.

15. The method of claim 14, wherein between approximately 5% and 50% of the heat seal coating comprises the anti-stick material.

16. The method of claim 12, further comprising crushing the fiber-based padding.

17. The method of claim 12, further comprising:
scoring a portion of the fiber-based liner.

18. A method of packaging an object, the method comprising:
applying a heat seal coating to a first side of a fiber-based padding;
adhering the fiber-based padding to a fiber-based web, wherein the fiber-based web defines a web width and a web length, and wherein the fiber-based padding defines a padding width, wherein the padding width is less than the web width, thereby defining a first overhang extending between a first edge of the fiber-based padding and a first edge of the fiber-based web, and a second overhang extending between a second edge the fiber-based padding and a second edge of the fiber-based web;
applying a heat seal coating to the first overhang and the second overhang;
adhering a second surface of the fiber-based padding to the fiber-based web;
positioning the object on the fiber-based padding;
folding the fiber-based web over the object; and
applying heat to the fiber-based web thereby forming a heat seal about the object.

19. The method of claim 18, wherein the heat seal is formed along the first overhang, the second overhang, and along a longitudinal axis of the fiber-based padding.

20. The method of claim 18, wherein the heat seal coating comprises an anti-stick material.

21. (canceled)
